(19) United States
(12) Patent Application Publication
(10) Pub. No.: US 2021/0214259 A1
(43) Pub. Date: Jul. 15, 2021

(54) GLASS PRODUCT FORMING MOLD AND METHOD OF PROCESSING GLASS PRODUCT

(71) Applicant: AAC Optics Solutions Pte. Ltd., Singapore city (SG)

(72) Inventors: Simon Bo Jensen, Hillerod (DK); Michal Sobol, Kobenhavn (PL); Tsz Lok Keith Tang, Hong Kong (CN); Thomas Aabo, Albertslund (DK); Jacob Kibsgaard Kjær, Soborg (DK); Peter Krohne Nielsen, Hillerod (DK); Niels Christian Roemer Holme, Farum (DK); Bingke Zhu, Shenzhen (CN)

(21) Appl. No.: 16/809,582

(22) Filed: Mar. 5, 2020

(30) Foreign Application Priority Data
Jan. 9, 2020 (CN) 202010023823.1

(51) Int. Cl. C03B 11/08

(52) U.S. Cl. CPC C03B 11/08; C03B 2215/50; C03B 2215/46

(57) ABSTRACT

A glass product forming mold includes a mold body and a plurality of ejector mechanisms disposed on the mold body at intervals. The mold body is defined a plurality of gaps surrounding separately the mold body, and each gap receives one ejector mechanism. The mold body includes a forming surface for forming a glass product, the ejector mechanism includes a first wedge configured to lift the glass product and a second wedge configured to drive the first wedge to move vertically with respect to the forming surface, and the first wedge is flush with the forming surface. After the formation of the glass product, the ejector mechanisms lift the glass product so that the glass product does not contact with the mold body, avoiding the deformation and crack of the glass product, ensuring the quality of the glass product, accelerating the cooling of the glass product.

### TECHNICAL FIELD

The disclosure relates to formations of glass products, and more particularly to a glass product forming mold and a method of processing the glass product.

### BACKGROUND

Lens is an optical element made of glass, which can be widely used in security, vehicle, digital camera, laser, optical instruments, and other fields. With the continuous expansion of the market, the application of lens is more and more extensive. Especially with the development of the Internet, various electronic devices are brought into daily lives, such as mobile phones, tablet computers, laptops, etc. Specification requirements of lens applied in those electronic devices are also highly increased.

In the prior art, products made of glass materials are generally produced by a glass processing mold through thermoforming. When the glass processing mold is enclosed, gaps with a preset shape will be encircled inside the glass processing mold; the gaps can help shape the heated glass substrate, and then the glass substrate is cooled to form glass products with a preset shape.

However, the processing of the glass processing mold in the prior art has the following problems:

Firstly, at the last step of the molding process, the glass product 401 may be stuck together with the feature points 403 of the mold 402, or it may be stuck together with the mold at a random point 404 to form a point contact. As shown in FIG. 5, where an arrow represents the shrinkage direction of the glass product. Because contacting area of the glass product tends to cool faster, it may cause an uneven shrinkage across the glass product, leading to a deformation of the glass product, as shown in FIG. 6.

Secondly, in the forming process, the glass product shows a strong adhesion to the mold surface. Although adhesion will gradually reduce during the cooling process, it takes a long time for the glass product to completely cool that leads to an auto release, thus increasing the cost. Besides, if the adhesion is too strong, the glass product tends to crack.

Thirdly, the mold with large angle feature will increase the risk of breakage of the glass product in the process of shrinkage, because the shrinkage rate of the glass product during the cooling process is greater than that of the mold, and the large angle feature of the mold will prevent the glass product from freely shrinking in the horizontal direction. The larger the diameter of the glass product, the greater the impact. Because the thermal expansion coefficient of the glass product 401 is larger than that of the mold 402, the glass product shrinks more, as shown in FIG. 7, where an arrow indicates the shrinkage direction of the glass product and the mold. When the strain caused by the shrinkage difference between the mold and the glass product goes beyond the strain that the glass product can sustain, the glass product will crack, as shown in FIG. 8.

Therefore, it is necessary to provide an improved mold to solve the above problems.

### SUMMARY

One of the objectives of the disclosure is to provide a glass product forming mold, so as to solve the problem that the product quality is adversely affected by the existing glass processing molds.

One of the objectives of the disclosure is realized by adopting the following technical scheme:

A glass product forming mold comprises a mold body and a plurality of ejector mechanisms disposed on the mold body at intervals; the mold body is defined a plurality of gaps surrounding separately the mold body, and each gap receives one of the plurality of ejector mechanisms; the mold body comprises a forming surface for forming a glass product, each of the plurality of ejector mechanisms comprises a first wedge configured to lift the glass product and a second wedge configured to drive the first wedge to move vertically with respect to the forming surface, and the first wedge is flush with the forming surface.

As an improvement, the first wedge comprises a first surface flush with the forming surface, a second surface opposite to the first surface, and a first inclined surface connecting to the first surface and the second surface; the inclined surface extends from the first surface to the second surface, and a distance between the first inclined surface and a central axis of the mold body gradually decreases; and the second wedge butts against the first inclined surface.

As an improvement, the second wedge comprises a second inclined surface corresponding to the first inclined surface; the second wedge is adapted to move towards the central axis of the mold body to drive the first wedge to lift the glass product and separate the glass product from the mold body.

As an improvement, the plurality of ejector mechanisms is circumferentially and equidistantly disposed on the mold body.

As an improvement, the glass product forming mold comprises four ejector mechanisms.

As an improvement, the glass product forming mold further comprises an assistant mold disposed on the mold body, and the glass product is sandwiched between the assistant mold and the mold body.

Another objective of the disclosure is to provide a method of processing a glass product, the method comprising:

providing the above-mentioned glass product forming mold and a glass substrate;

placing the glass substrate in the glass product to form a glass product;

driving the second wedge to move towards the first wedge when a temperature of the glass product decreasing below a glass transition temperature to drive the first wedge to lift the glass product with respect to the forming surface and separate the glass product from the mold body; and

cooling the glass product.

As an improvement, after the step of cooling the glass product, the method of processing the glass product further comprises a step of removing the glass product and driving the second wedge to move away from the first wedge and descend the first wedge into the gaps.

Advantages of the disclosure are summarized as follows: after formation of the glass product, the ejector mechanisms of the glass product forming mold provided by the embodiment of the disclosure lifts the glass product. Since the glass product does not contact the mold body, the deformation of the glass product due to the uneven heat distribution or excessive adhesion caused by the contact between the glass product and the mold body during the cooling process is avoided, and the quality of the glass product is assured. Besides, because the glass product does not contact the mold body, the cooling speed of the glass product is accelerated, which can shorten the production cycle of the glass product, and the glass product will not be hindered by the mold body in the process of cooling shrinkage, so as to avoid the risk of cracking of the glass product due to the different thermal expansion coefficients of the mold body and the glass product.

### BRIEF DESCRIPTION OF THE DRAWINGS

FIG. 1 is a schematic diagram of a glass product forming mold according to one embodiment of the disclosure;

FIG. 2 is an exploded view of a mold body and a plurality of ejector mechanisms according to one embodiment of the disclosure;

FIG. 3 is a sectional view taken from line A-A in FIG. 1;

FIG. 4 is a combined diagram of a mold body, a plurality of ejector mechanisms and a glass product according to one embodiment of the disclosure, where the glass product is separated from the mold body;

FIG. 5 is a schematic diagram of a glass product and a mold in the prior art;

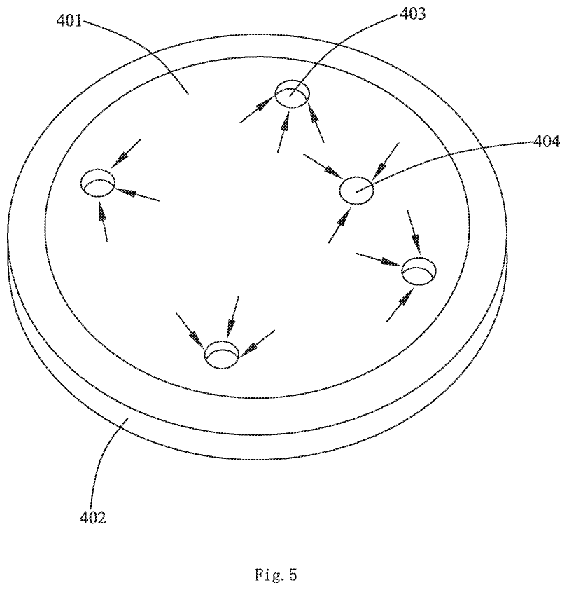

FIG. 6 shows the deformation of a glass product due to uneven heat distribution in the prior art;

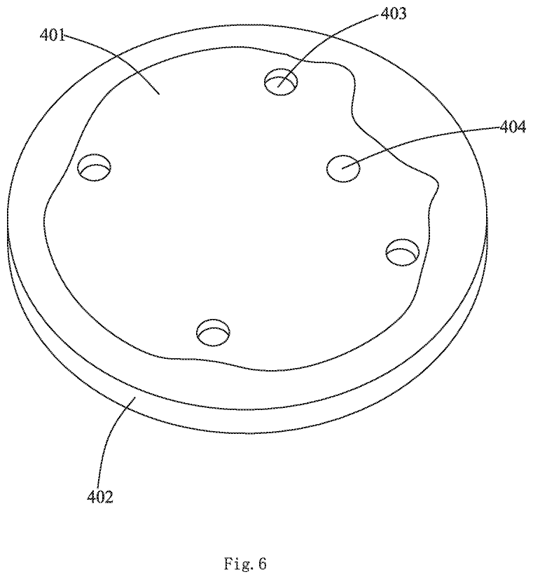

FIG. 7 shows the shrinkage of a glass product and a mold in the prior art; and

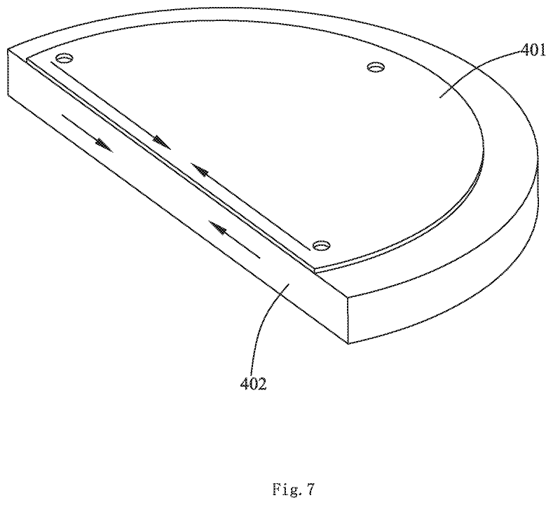

FIG. 8 shows the break of a glass product due to different shrinkage in the prior art.

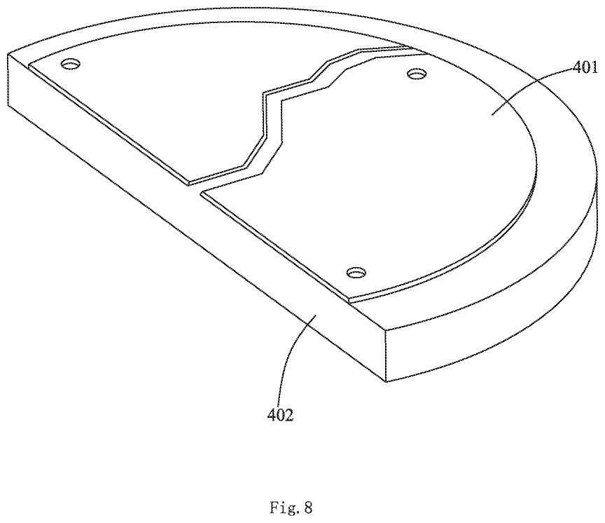

In the drawings, the following reference numbers are used: 10. Glass product; 100. Glass product forming mold; 1. Mold body; 11. Forming surface; 2. Ejector mechanism; 21. First wedge; 211. First surface; 212. Second surface; 213. First inclined surface; 22. Second wedge; 221. Second inclined surface; 3. Gap; 4. Assistant mold.

### DETAILED DESCRIPTION OF THE PREFERRED EMBODIMENTS

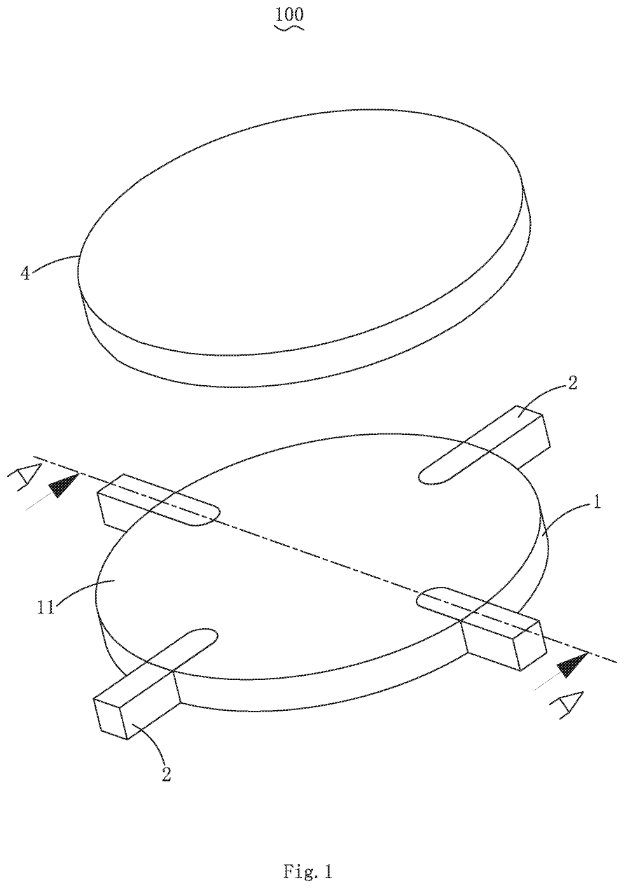

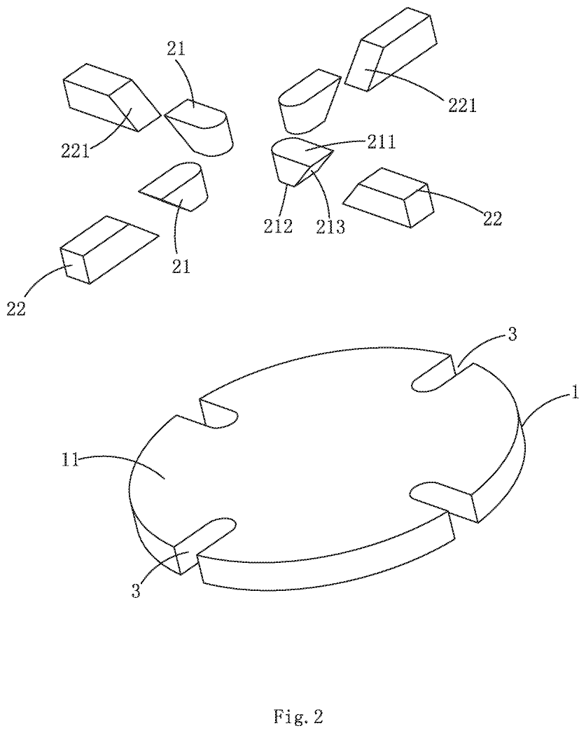

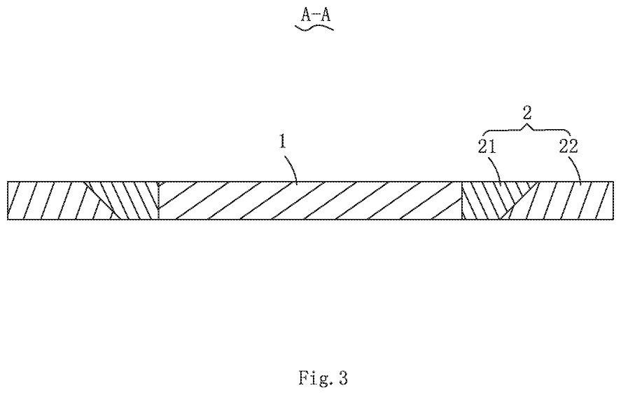

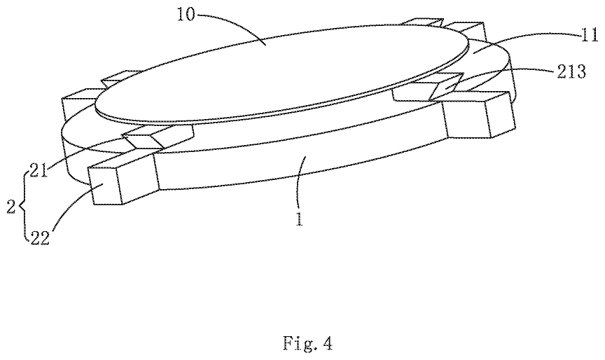

The disclosure is described in detail below in combination with FIGS. 1 to 4.

As shown in FIGS. 1-4, the disclosure provides a glass product forming mold 100 comprising a mold body 1 and a plurality of ejector mechanisms 2 disposed on the mold body 1 at intervals. The mold body 1 is defined a plurality of gaps 3 surrounding separately the mold body 1, and each gap 3 receives one of the plurality of ejector mechanisms 2. The mold body 1 comprises a forming surface 11 for forming a glass product 10, each of the plurality of ejector mechanisms 2 comprises a first wedge 21 configured to lift the glass product 10 and a second wedge 22 configured to drive the first wedge 21 to move vertically with respect to the forming surface 11, and the first wedge 21 is flush with the forming surface 11. The glass product forming mold 100 further comprises an assistant mold 4 disposed on the mold body 1, and the glass product 10 is sandwiched between the assistant mold 4 and the mold body 1. The plurality of ejector mechanisms 2 is configured to separate the formed glass product 10 from the mold body 1. The plurality of ejector mechanisms 2 is circumferentially disposed on the mold body 1 to support the glass product 10 simultaneously, so that the glass product 10 is provided with a plurality of support points. This balances the stress of the glass product 10 and can smoothly separate the glass product from the mold body 1, and the glass product 10 can stably locate on the ejector mechanisms 2. The first wedge 21 can vertically move with respect to the forming surface 11 and the second wedge 22 can drives the first wedge 21 to move, thus achieving the ejection function of the ejector mechanisms 2. It can be understood that the first wedge 21 can also be lower than the forming surface 11, as long as it can meet the requirement that the second wedge 22 can drive the first wedge 21 to a position higher than the forming surface 11, that is to say, under the driving effect of the second wedge 22, the plurality of first wedge 21 carry the glass product 10 and separate it from the mold body 1. The glass product 10 can be a lens, a grating, or other products.

After the glass product 10 is formed, the ejector mechanisms 2 of the glass product forming mold 100 provided by the embodiment of the disclosure lifts the glass product 10. Since the glass product 10 does not contact the mold body 1, the deformation of the glass product 10 due to the uneven heat distribution or excessive adhesion caused by the contact between the glass product 10 and the mold body 1 during the cooling process is avoided, and the quality of the glass product 10 is assured. Besides, because the glass product 10 does not contact the mold body 1, the cooling speed of the glass product 10 is accelerated, which can shorten the production cycle of the glass product 10, and the glass product 10 will not be hindered by the mold body 1 in the process of cooling shrinkage, so as to avoid the risk of cracking of the glass product 10 due to the different thermal expansion coefficients of the mold body 1 and the glass product 10. The thermal expansion coefficient refers to the expansion and shrinkage of an object due to the change of temperature. The larger the thermal expansion coefficient is, the greater the shrinkage degree will be.

Preferably, the first wedge 21 comprises a first surface 211 flush with the forming surface 11, a second surface 212 opposite to the first surface 211, and a first inclined surface 213 connecting to the first surface 211 and the second surface 212; the inclined surface 213 extends from the first surface 211 to the second surface 212, the distance between the first inclined surface 213 and the central axis of the mold body 1 gradually decreases; and the second wedge 22 butts against the first inclined surface 213. The second wedge 22 comprises a second inclined surface 221 corresponding to the first inclined surface 213. The second wedge 22 is adapted to move towards the central axis of the mold body 1 to drive the first wedge 21 to lift the glass product 10 and separate the glass product 10 from the mold body 1. The first wedge 21 is connected to the second wedge 22 via the first inclined surface 213 and the second inclined surface 221; the inclined surface 213 extends from the first surface 211 to the second surface 212, the distance between the first inclined surface 213 and the central axis of the mold body 1 gradually decreases. In this way, a force is produced and exerted on the first wedge 21 when the second wedge 22 move towards the mold body 1; the first wedge 21 moves vertically with respect to the forming surface 11, to separate the glass product 10 from the mold body 1.

In this example, the glass product forming mold 100 comprises four ejector mechanisms 2 circumferentially and equidistantly disposed on the mold body 1. The ejector mechanisms 2 are disposed at equal intervals to make the force exerted on the glass product 10 more uniform, and the glass product 10 is stably separated from the mold body 1. Understandably, the number of the ejector mechanisms 2 is changeable according to the actual situation, for example, five, six and seven. Besides, it is also possible to arrange the ejector mechanisms 2 at unequal intervals, as long as the force exerted on the glass product 10 by the ejector mechanisms 2 is balanced, so that the glass product 10 can be stably separated from the mold body 1.

The disclosure also provides a method of processing a glass product, the method comprising:

providing the aforesaid glass product forming mold 100 and a glass substrate;

placing the glass substrate in the glass product forming mold 100 to form a glass product 10;

driving the second wedge 22 to move towards the first wedge 21 when a temperature of the glass product decreasing below a glass transition temperature to drive the first wedge 21 to lift the glass product 10 with respect to the forming surface 11 and separate the glass product 10 from the mold body 1;

cooling the glass product 10; and

removing the glass product 10, and driving the second wedge 22 to move away from the first wedge 21 and descend the first wedge 21 into the gaps 3.

It can be understood that glass product 10 can also be removed when it is not completely cooled.

Based on the method of processing a glass product of the disclosure, when the glass product 10 is cooled below the glass transition temperature, the ejector mechanisms 2 lift the glass product 10. Since the glass product 10 does not contact the mold body 1, the deformation of the glass product 10 due to the uneven heat distribution or excessive adhesion caused by the contact between the glass product 10 and the mold body 1 during the cooling process is avoided, and the quality of the glass product 10 is assured. Besides, because the glass product 10 does not contact the mold body 1, the cooling speed of the glass product 10 is accelerated, which can shorten the production cycle of the glass product 10, and the glass product 10 will not be hindered by the mold body 1 in the process of cooling shrinkage, so as to avoid the risk of cracking of the glass product 10 due to the different thermal expansion coefficients of the mold body 1 and the glass product 10.

The glass transition temperature refers to a temperature at which the glass can transform from a high elastic state to a glass state or from a glass state to a high elastic state. The glass product is in a high elastic state in an environment with a temperature higher than the glass transition temperature, at this time, the glass product is easily deformed in the presence of an external force. The glass product is in a glass state in an environment with a temperature lower than the glass transition temperature, at this time, the glass product has certain rigidity, it is difficult to deform even in the presence of an external force. Therefore, only when the temperature of the glass product 10 drops below the glass transition temperature, the first wedge 21 can be driven to rise, so as to avoid the deformation of the glass product 10 caused by the rise of the first wedge 21.

The above embodiments are only the preferred embodiments of the present disclosure, and do not limit the scope of the present disclosure. A person skilled in the art may make various other corresponding changes and deformations based on the described technical solutions and concepts. And all such changes and deformations shall also fall within the scope of the present disclosure.

1. A glass product forming mold, comprising:
a mold body defining a plurality of gaps surrounding separately the mold body; and
a plurality of ejector mechanisms disposed on the mold body at intervals;
wherein each gap receives one of the plurality of ejector mechanisms; the mold body comprises a forming surface for forming a glass product, each of the plurality of ejector mechanisms comprises a first wedge configured to lift the glass product and a second wedge configured to drive the first wedge to move vertically with respect to the forming surface, and the first wedge is flush with the forming surface.

2. The glass product forming mold of claim 1, wherein the first wedge comprises a first surface flush with the forming surface, a second surface opposite to the first surface, and a first inclined surface connecting to the first surface and the second surface; the inclined surface extends from the first surface to the second surface, and a distance between the first inclined surface and a central axis of the mold body gradually decreases; and the second wedge butts against the first inclined surface.

3. The glass product forming mold of claim 2, wherein the second wedge comprises a second inclined surface corresponding to the first inclined surface; the second wedge is adapted to move towards the central axis of the mold body to drive the first wedge to lift the glass product and separate the glass product from the mold body.

4. The glass product forming mold of claim 3, wherein the plurality of ejector mechanisms is circumferentially and equidistantly disposed on the mold body.

5. The glass product forming mold of claim 4, wherein the glass product forming mold comprises four ejector mechanisms.

6. The glass product forming mold of claim 1, further comprising an assistant mold disposed on the mold body, and the glass product is sandwiched between the assistant mold and the mold body.

7. A method of processing a glass product, comprising:
providing a glass product forming mold of claim 1 and a glass substrate;
placing the glass substrate in the glass product forming mold to form a glass product;
driving the second wedge to move towards the first wedge when a temperature of the glass product decreasing below a glass transition temperature to drive the first wedge to lift the glass product with respect to the forming surface and separate the glass product from the mold body; and
cooling the glass product.

8. The method of processing the glass product of claim 7, wherein after the step of cooling the glass product, the method of processing the glass product further comprises a step of removing the glass product and driving the second wedge to move away from the first wedge and descend the first wedge into the gaps.
